(19) United States
(12) Patent Application Publication
(10) Pub. No.: US 2015/0010877 A1
(43) Pub. Date: Jan. 8, 2015

(54) HIGH PRESSURE CONTAINER

(71) Applicant: Shuen Hwa Enterprise Co., Ltd., Taipei (TW)

(72) Inventor: Kuo Liang CHAN, Taipei (TW)

(73) Assignee: Shuen Hwa Enterprise Co., Ltd., Taipei (TW)

(21) Appl. No.: 14/279,472

(22) Filed: May 16, 2014

(30) Foreign Application Priority Data
Jul. 5, 2013 (TW) 102212733

(51) Int. Cl. F27D 7/06

(52) U.S. Cl. CPC F27D 7/06; F27D 2007/063
USPC 432/205

(57) ABSTRACT

A high pressure container includes a casing disposed in a housing and spaced from the housing for forming a peripheral space between the housing and the casing, the casing includes a compartment and spaced from the peripheral space that is formed between the housing and the casing, and a pressurizing device is connected to the compartment of the casing with a pipe for supplying a heated or pressurized air into the casing in order to heat or pressurize the work piece to the required higher pressure or temperature, and the pressurizing device is coupled to the peripheral space that is formed between the housing and the casing with a tube for supplying a pressurized air into the peripheral space for balancing the pressure.

### BACKGROUND OF THE INVENTION

1. Field of the Invention

The present invention relates to a high pressure container, and more particularly to a high temperature and high pressure container including an improved structure or configuration for heating the work piece to a higher temperature and resisting a higher pressure and for allowing the high temperature container to be quickly lowered to a lower temperature.

2. Description of the Prior Art

Typical steel materials are required to be subjected with various heating processes or procedures with various kinds of furnace facilities, and the furnace facilities normally will be heated to a higher temperature and a higher pressure in order to make or manufacture the required products.

For example, U.S. Pat. No. 4,227,874 to Nugent, U.S. Pat. No. 4,582,301 to Wunning, U.S. Pat. No. 4,767,320 to Sasaki et al., U.S. Pat. No. 5,848,890 to McCormick, and U.S. Pat. No. 7,520,746 to Johnston et al. disclose several of the typical furnace product supporting or transporting devices for supporting or transporting the typical steel plates or members into and out of the typical steel furnaces which will be heated to a higher temperature and a higher pressure in order to make or manufacture the required products.

However, the typical furnaces are normally required to be formed or provided with a great thickness for resisting the higher pressure and the higher temperature, but it will take a long time to heat the typical furnaces or the typical high pressure containers to the required temperature, and it will also take a long time to have the typical furnaces or the typical high pressure containers cooled to the required temperature.

Recently, various kinds of electrical products are required to be heated to a higher temperature and also required to be pressurized to a higher pressure in order to heat and harden the solidified materials, such as the thermoplastic materials that will normally be attached or mounted or secured onto the electrical products, and it is required to have the solidified materials or thermoplastic materials be hardened before boiling.

However, the typical furnaces or high pressure containers may take a long time to heat the solidified materials or thermoplastic materials to the required temperature, and it will also take a long time to have the solidified materials or thermoplastic materials cooled to the required temperature, such that the timing for making or manufacturing the required products may not be suitably controlled.

The present invention has arisen to mitigate and/or obviate the afore-described disadvantages of the conventional steel high pressure containers.

### SUMMARY OF THE INVENTION

The primary objective of the present invention is to provide a high temperature and high pressure container including an improved structure or configuration for heating the work piece to a higher temperature and resisting a higher pressure and for allowing the high temperature container to be quickly lowered to a lower temperature.

In accordance with one aspect of the invention, there is provided a high pressure container comprising a housing including a chamber formed therein, a casing disposed in the chamber of the housing and spaced from the housing for forming a peripheral space between the housing and the casing, the casing including a compartment formed therein and spaced from the peripheral space that is formed between the housing and the casing, and a pressurizing device connected to the compartment of the casing with a pipe for filling or supplying the heated and/or pressurized air into the compartment of the casing in order to heat and/or pressurize the work piece to the required higher pressure and the required higher temperature, and the pressurizing device is coupled to the peripheral space that is formed between the housing and the casing with a tube for filling or supplying the pressurized air into the peripheral space that is formed or provided between the housing and the casing for balancing the pressure within both the compartment of the casing and the peripheral space that is formed or provided between the housing and the casing, and for preventing the space from being distorted or twisted.

The housing includes an insert disposed and engaged in the peripheral space that is formed between the housing and the casing, and the insert is preferably made of a heat resistive material for heat resistive or heat insulating purposes. The pressurizing device includes a check valve engaged in the pipe, and includes a check valve engaged in the tube for allowing the pressurizing device to supply the pressurized air or to pressurize the compartment of the casing and the peripheral space that is formed or provided between the housing and the casing only, and for preventing the pressurized air from flowing backward from the casing and the peripheral space that is formed or provided between the housing and the casing into the pressurizing device.

The housing includes a one or first end portion, the housing and the casing are preferably coupled together at the one or first end portion of the housing with a coupling member or flange which is extended and coupled between the housing and the casing for blocking or enclosing the peripheral space that is formed between the housing and the casing and for solidly and stably retaining or confining or positioning and securing the insert within the peripheral space that is formed or provided between the housing and the casing.

The housing includes an open end portion, and a cover engaged with the open end portion of the housing for blocking and enclosing the open end portion of the housing for suitably retaining or confining or positioning the work piece within the compartment of the casing. The cover includes a heat resistive inner element attached to an inner portion of the cover and located in the compartment of the casing for heat resistive or heat insulating purposes. The casing includes a thickness smaller than that of the housing for allowing the casing to be easily and quickly heated and increased to the higher and required temperature, and also for allowing the casing to be easily and quickly cooled and lowered to the lower and required temperature. The combination of the casing and the housing may form a strong structure or configuration to resist a higher pressure.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a cross sectional view of a high pressure container in accordance with the present invention.

### DETAILED DESCRIPTION OF THE PREFERRED EMBODIMENT

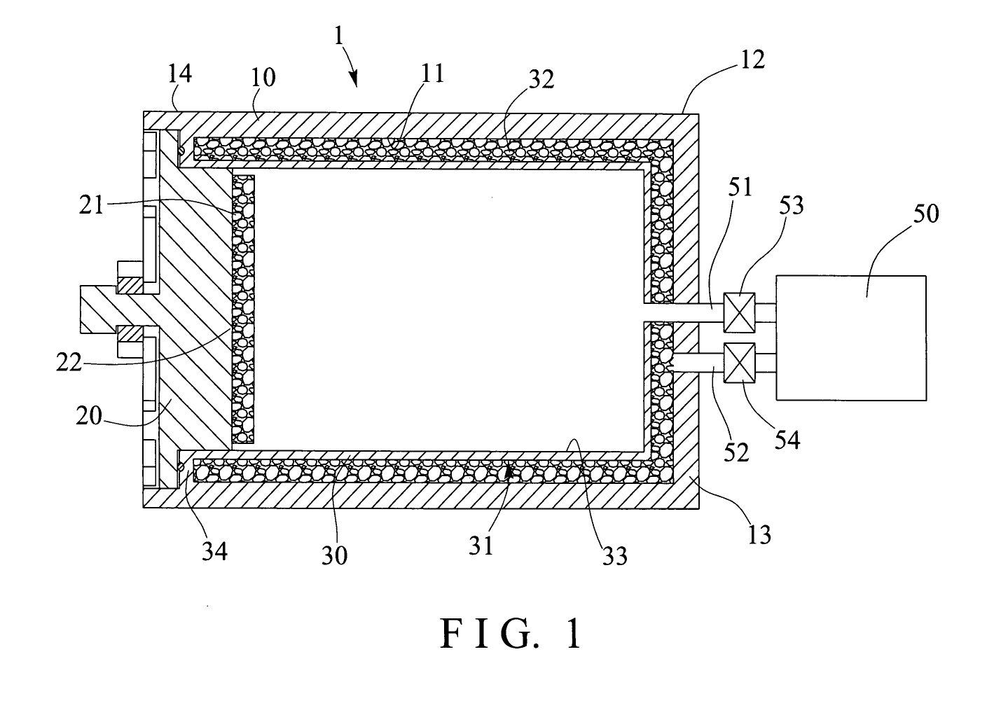

Referring to the drawing FIG. 1, a furnace facility or high pressure container 1 in accordance with the present invention comprises an outer receptacle or container or housing 10 including a compartment or space or chamber 11 formed therein, and including one or first end portion 12 having an end panel or end wall 13 formed or provided therein, and including an open or other or second end portion 14 for receiving or engaging with a cover 20 which may be solidly and stably attached or mounted or secured to the housing 10 with latches or locks or catches or fastening materials or members or elements (not illustrated) or the like for suitably blocking or enclosing the open or second end portion 14 of the housing 10.

The housing 10 further includes an inner receptacle or casing 30 disposed or attached or mounted or supported or engaged in the chamber 11 of the housing 10, and preferable, but not necessary that the casing 30 is arranged parallel to the housing 10, the casing 30 is disengaged or separated or spaced from the housing 10 for a suitable or selected distance and for forming or defining a peripheral chamber or channel or gap or space 31 between the housing 10 and the casing 30, and for receiving or engaging with a filling material or element or insert 32, selected from or made of such as the foam rubber or foamable materials which are heat resistive or heat insulated materials.

The casing 30 includes an inner chamber or compartment 33 formed therein for receiving or accommodating the products or materials or work pieces (not illustrated) to be heated or treated with the high pressure container 1. It is preferable, but not necessary that the housing 10 and the casing 30 are joined or secured or coupled together at the second end portion 14 of the housing 10 with a connecting or coupling flange 34; i.e., the coupling flange 34 is extended and coupled between the housing 10 and the casing 30 for suitably blocking or enclosing the peripheral space 31 that is formed or provided between the housing 10 and the casing 30, and for solidly and stably retaining or confining or positioning the insert 32 within the peripheral space 31 that is formed or provided between the housing 10 and the casing 30. The compartment 33 of the casing 30 is not communicating with, or is disengaged or separated or spaced from the peripheral space 31 that is formed or provided between the housing 10 and the casing 30.

The cover 20 may further include a heat resistive insert or inner material or element 21 attached or mounted or secured onto or engaged with the inner portion 22 of the cover 20 and arranged or disposed or located in the compartment 33 of the casing 30 for forming or defining the compartment 33 of the casing 30 that is heat resistive and pressure resistive. The casing 30 includes a thickness smaller than that of the housing 10 for allowing the casing 30 to be easily and quickly heated and increased to the higher and required temperature, and also for allowing the casing 30 to be easily and quickly cooled and lowered to the lower and required temperature. The combination or assembly of the casing 30 and the housing 10 may form a strong structure or configuration to resist a higher pressure.

The high pressure container 1 further includes a pressurizing and/or heating facility or mechanism or device 50 connected or coupled to the compartment 33 of the casing 30 with a pipe 51, and connected or coupled to the peripheral space 31 that is formed or provided between the housing 10 and the casing 30 with a tube 52, and a check valve 53 is disposed or attached or mounted or engaged in the pipe 51, and another check valve 54 is disposed or attached or mounted or engaged in the tube 52 for allowing the pressurizing device 50 to supply the pressurized air, or to pressurize the compartment 33 of the casing 30 and the peripheral space 31 that is formed or provided between the housing 10 and the casing 30 only, and for preventing the pressurized air from flowing backward into the pressurizing device 50.

In operation, as shown in FIG. 1, the pressurizing device 50 may fill or send or generate and supply the heated and/or pressurized air into the compartment 33 of the casing 30 in order to heat and/or to pressurize the work piece in the compartment 33 of the casing 30 to the required higher pressure and the required higher temperature, and the pressurizing device 50 may also fill or supply the pressurized air into the peripheral space 31 that is formed or provided between the housing 10 and the casing 30 for balancing the pressure within both the compartment 33 of the casing 30 and the peripheral space 31 that is formed or provided between the housing 10 and the casing 30, and for preventing the space 31 from being distorted or twisted.

In addition, the insert 32 which is made of heat resistive or heat insulated materials and which is contained or received or accommodated or engaged within the peripheral space 31 that is formed or provided between the housing 10 and the casing 30 may prevent the housing 10 from being heated, and allows only the casing 30 to be heated and increased to the higher and required temperature, and also allows the casing 30 to be easily and quickly cooled and lowered to the lower and required temperature, such that the working hours and the man powers may be suitably decreased and/or economized.

Accordingly, the high temperature and high pressure container in accordance with the present invention includes an improved structure or configuration for heating the work piece to a higher temperature and resisting a higher pressure and for allowing the high temperature container to be quickly lowered to a lower temperature.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A high pressure container comprising:
a housing including a chamber formed therein,
a casing disposed in said chamber of said housing and spaced from said housing for forming a peripheral space between said housing and said casing, said casing including a compartment formed therein and spaced from said peripheral space that is formed between said housing and said casing, and
a pressurizing device connected to said compartment of said casing with a pipe, and coupled to said peripheral space that is formed between said housing and said casing with a tube.

2. The high pressure container as claimed in claim 1, wherein said housing includes an insert disposed and engaged in said peripheral space that is formed between said housing and said casing.

3. The high pressure container as claimed in claim 2, wherein said insert is made of a heat resistive material.

4. The high pressure container as claimed in claim 1, wherein said pressurizing device includes a check valve engaged in said pipe.

5. The high pressure container as claimed in claim 1, wherein said pressurizing device includes a check valve engaged in said tube.

6. The high pressure container as claimed in claim 1, wherein said housing includes an end portion, said housing and said casing are coupled together at said end portion of said housing with a coupling flange which is extended between said housing and said casing for enclosing said peripheral space that is formed between said housing and said casing.

7. The high pressure container as claimed in claim 1, wherein said housing includes an open end portion, and a cover engaged with said open end portion of said housing for blocking and enclosing said open end portion of said housing.

8. The high pressure container as claimed in claim 7, wherein said cover includes a heat resistive inner element attached to an inner portion of said cover and located in said compartment of said casing.

9. The high pressure container as claimed in claim 1, wherein said casing includes a thickness smaller than that of said housing.
